(19) United States
(12) Patent Application Publication
(10) Pub. No.: US 2023/0298134 A1
(43) Pub. Date: Sep. 21, 2023

(54) SYSTEM FOR ACQUIRING HIGH-RESOLUTION IMAGES

(71) Applicant: ISORG, Limoges CEDEX 3 (FR)

(72) Inventors: Wilfrid SCHWARTZ, GRENOBLE (FR); Delphine DESCLOUX, GRENOBLE (FR)

(21) Appl. No.: 18/021,546

(22) PCT Filed: Aug. 12, 2021
(86) PCT No.: PCT/EP2021/072550

§ 371 Date: Feb. 15, 2023

(30) Foreign Application Priority Data
Aug. 17, 2020 (FR) 20/08535

(51) Int. Cl. G06T 3/40; G06V 40/13

(52) U.S. Cl. CPC G06T 3/4053; G06V 40/13; G06T 2207/10

(57) ABSTRACT

A system for acquiring images of an object includes a stack of layers having a total thickness smaller than 600 μm. The stack of layers includes an image sensor, a source of a radiation (RF), and an angular filter that covers the image sensor and is interposed between the source and the image sensor. The image sensor has an array of photodetectors. The source of the radiation (RF) has a thickness smaller than 400 μm and includes first and second opposite surfaces. The second surface faces a side of the image sensor. A surface density of an energy flux emitted by the source through the first surface is greater than 100 μW/cm². The ratio of the surface density of the energy flux emitted by the source through the second surface and the first surface is smaller than 0.4. A transmittance of the source to a portion of the radiation is greater than 15%.

### RELATED APPLICATIONS

The present patent application claims the priority benefit of French patent application FR20/08535 which is herein incorporated by reference.

### FIELD

The present disclosure generally relates to a high-resolution image acquisition system, more particularly an image acquisition system comprising a light source.

### BACKGROUND

FIG. 1 is a partial simplified cross-section view of an example of a system 1 for acquiring images of an object 2, for example, for the acquisition of the fingerprint of a finger.

Image acquisition system 1 comprises, from bottom to top in FIG. 1:
a luminous tile 3;
a support 4 transparent to the radiation supplied by luminous tile 3;
an image sensor 5 comprising an array of photosensitive cells 6, also called photodetectors; and
a coating 7.

Luminous tile 3 emits a forward radiation RF which is reflected by the object 2 to be imaged, the reflected radiation RR being captured by photodetectors 6. The use of a luminous tile 3 particularly enables to acquire images independently from the ambient light conditions.

A screen generally has to be provided between each photosensitive cell 6 and luminous tile 3 to avoid for photodetectors 6 to be saturated by forward radiation RF. A disadvantage of the image acquisition system 1 shown in Figure is that it may however be difficult to completely prevent the oblique rays of incident radiation RI from directly reaching photodetectors 6.

Another disadvantage of the image acquisition system 1 shown in FIG. 1 is that, in addition to the reflected radiation RR originating from the specular reflection of incident radiation RI on the object 2 to be detected, a radiation reflected by diffusion RD which is also captured by photodetectors 6 and which degrades the images acquired by acquisition system 1 can be observed.

### SUMMARY

Thus, an object of an embodiment is to at least partly overcome the disadvantages of previously-described image acquisition systems.

Another object of an embodiment is to improve the quality of the images acquired by the image acquisition system.

Another object of an embodiment is for risks of saturation of the photodetectors by direct exposure to the radiation emitted by the light source to be decreased.

Another object of an embodiment is for the distance between the object to be imaged and the sensitive portion of the image acquisition system to be shorter than one centimeter.

Another object of an embodiment is for the method of manufacturing the image acquisition system to be implementable at an industrial scale.

An embodiment provides a system for acquiring images of an object comprising a stack of layers having a total thickness smaller than 600 μm, said stack comprising:
an image sensor comprising an array of photodetectors;
a source of a radiation having a thickness smaller than 400 μm and comprising first and second opposite surfaces, said source comprising a non-pixelated organic light-emitting diode covering the entire image sensor or comprising a light guide covering the entire image sensor, the photodetectors being adapted to detecting at least a portion of said radiation reflected by the object, the second surface facing the side of the image sensor, the second surface covering the entire photodetector array, the surface density of the energy flux emitted by the source through the first surface being greater than 100 μW/cm², the ratio of the surface density of the energy flux emitted by the source through the second surface to the surface density of the energy flux emitted by the source through the first surface being smaller than 0.4, the transmittance of the source to said portion of the radiation being greater than 15%; and an angular filter covering the image sensor and interposed between the source and the image sensor, and adapted to blocking the rays of said radiation having an incidence relative to a direction orthogonal to the first surface greater than a threshold and to giving way to rays of said radiation having an incidence relative to a direction orthogonal to the first surface smaller than the threshold.

According to an embodiment, the light guide comprises a core interposed between first and second sheaths, the second sheath being arranged between the core and the angular filter, the refraction index of the core for the radiation being greater than the refraction index of the first and second sheaths for the radiation.

According to an embodiment, the image acquisition system comprises, between the second sheath and the core, micrometer-range patterns projecting in relief from the second sheath into the core.

According to an embodiment, the light guide comprises an area through which the radiation is injected into the light guide, and the surface density of the patterns on the second sheath increases as the distance to said area increases.

According to an embodiment, the radiation is in the visible range and/or in the infrared range.

According to an embodiment, the angular filter comprises:
an array of micrometer-range focusing elements; and
a layer opaque to the radiation and crossed by holes, the holes being filled with air or with a material at least partially transparent to said radiation.

According to an embodiment, for each hole, the ratio of the height of the hole, measured perpendicularly to the first surface, to the width of the hole, measured parallel to the first surface, varies from 1 to 10.

According to an embodiment, the holes are arranged in rows, the pitch between adjacent holes of a same row or of a same column varying from 1 μm to 30 μm.

According to an embodiment, the height of each hole, measured along a direction orthogonal to the first surface, varies from 1 μm to 1 mm.

According to an embodiment, the width of each hole, measured parallel to the first surface, varies from 2 μm to 30 μm.

According to an embodiment, the micrometer-range focusing elements are micrometer-range lenses.

According to an embodiment, the photodetectors comprise organic photodiodes.

According to an embodiment, the image acquisition system further comprises a polarizer covering the first surface.

According to an embodiment, the image acquisition system further comprises a second polarizer.

According to an embodiment, the first polarizer is interposed between the light source and the object to be imaged and the second polarizer is interposed between the light source and the angular filter.

An embodiment also provides using the image acquisition system such as previously described for the detection of an object, particularly at least one fingerprint of a user, by contact imaging.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1, previously described, shows an example of an image acquisition system;

FIG. 2 shows an embodiment of an image acquisition system;

FIG. 3 shows a more detailed embodiment of the light source of the image acquisition system of FIG. 2;

FIG. 4 is a top view of the light source of FIG. 3;

FIG. 5 shows another more detailed embodiment of the light source of the image acquisition system of FIG. 2;

FIG. 6 shows an embodiment of the light guide of FIG. 5;

FIG. 7 shows an embodiment of the angular filter of the image acquisition system of FIG. 2;

FIG. 8 is a simplified bottom view of the angular filter of FIG. 7;

FIG. 9 shows a variant of the angular filter of FIG. 7;

FIG. 10 shows another embodiment of an image acquisition system;

FIG. 11 shows another embodiment of an image acquisition system;

FIG. 12 shows an image obtained with the acquisition system of FIG. 2;

FIG. 13 shows an image obtained with the acquisition system of FIG. 11;

FIG. 14A illustrates a step of an embodiment of a method of manufacturing the light guide of FIG. 6;

FIG. 14B illustrates another step of the manufacturing method; and

FIG. 14C illustrates another step of the manufacturing method.

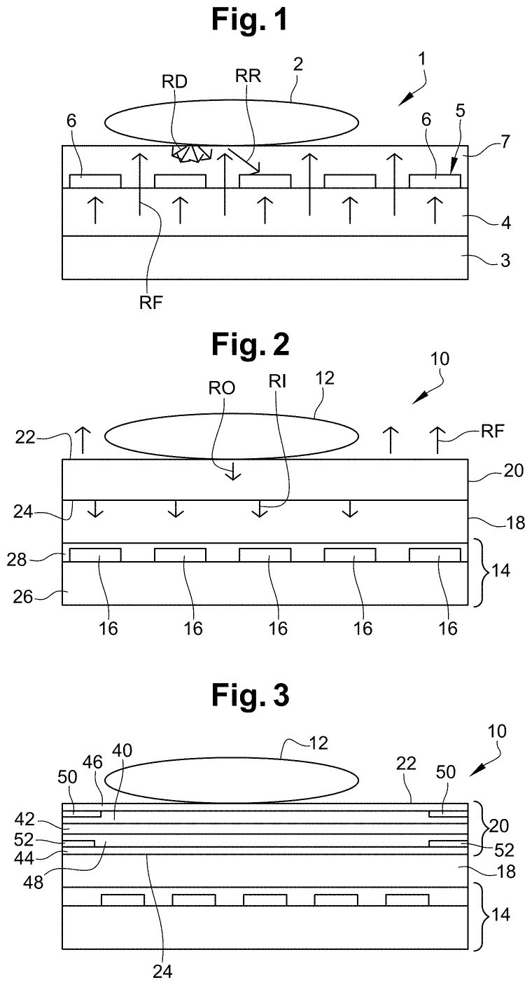

### DESCRIPTION OF THE EMBODIMENTS

Like features have been designated by like references in the various figures. In particular, the structural and/or functional features that are common among the various embodiments may have the same references and may dispose identical structural, dimensional and material properties. Further, only those elements which are useful to the understanding of the present description have been shown and will be described. In particular, the means for processing the signals supplied by the image acquisition systems described hereafter are within the abilities of those skilled in the art and will not described.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, it is referred to the orientation of the drawings or to an image acquisition system in a normal position of use. Unless specified otherwise, the expressions “around”, “approximately”, “substantially” and “in the order of” signify within 10%, and preferably within 5%. In the case of an angle, unless otherwise indicated, the expressions “about”, “approximately”, “substantially”, and “in the order of” mean within 10°. Further, it is here considered that the terms “insulating” and “conductive” respectively mean “electrically insulating” and “electrically conductive”.

In the following description, the inner transmittance of a layer corresponds to the ratio of the intensity of the radiation coming out of the layer to the intensity of the radiation entering in the layer. The absorption of the layer is equal to the difference between number 1 (which corresponds to a perfect transmittance for which the entire incident light is transmitted) and the inner transmittance. In the following description, a layer is said to be transparent to a radiation when the absorption of the radiation through the layer is smaller than 75%. In the following description, a layer is called absorbing or opaque to a radiation when the absorption of the radiation in the layer is greater than 75%. When a radiation exhibits a generally “bell”-shaped spectrum, for example, of Gaussian shape, having a maximum, wavelength of the radiation, or central or main wavelength of the radiation, designates the wavelength at which the maximum of the spectrum is reached. In the following description, the refraction index of a material corresponds to the refraction index of the material for the wavelength range of the radiation emitted by the light source of the image acquisition system. Unless indicated otherwise, the refraction index is considered as substantially constant over the wavelength range of the radiation emitted by the light source of the image acquisition system, for example, equal to the average of the refraction index over the wavelength range of the radiation emitted by the light source of the image acquisition system.

Further, in the following description, “useful radiation” designates the electromagnetic radiation captured by the image sensor of the image acquisition system and useful wavelength designates the central wavelength of the useful radiation. In the following description, visible light designates an electromagnetic radiation having a wavelength in the range from 400 nm to 700 nm and infrared radiation designates an electromagnetic radiation having a wavelength in the range from 700 nm to 1 mm. In infrared radiation, one can particularly distinguish near infrared radiation having a wavelength in the range from 700 nm to 1.4 μm.

FIG. 2 is a partial simplified cross-section view of an embodiment of an image acquisition system 10 of an object 12. Image acquisition system 10 comprises, from bottom to top in FIG. 2:
an image sensor 14 comprising an array of photodetectors 16;
an angular filter 18; and
a light source 20, angular filter 18 being interposed between image sensor 14 and light source 20.

Image acquisition system 10 further comprises means, not shown, for processing the signals output by image sensor 14, for example comprising a microprocessor.

In the present embodiment, light source 20 is interposed between the object 12 to be imaged and image sensor 14. Light source 20 comprises an upper surface 22 facing the side of object 12 and a lower surface 24 opposite to upper surface 22 and facing the side of angular filter 18. Preferably, surfaces 22 and 24 are planar and parallel.

Source 20 emits forward radiation RF through upper surface 22. Part of forward radiation RF is reflected and/or diffused by object 12 and forms a radiation RO returned towards image acquisition system 10. Source 20 further emits a backward radiation through lower surface 24. The entire radiation, called incident radiation RI hereafter, which reaches angular filer 18 comprises the backward radiation emitted by source 20 and the portion of the radiation RO returned before having crossed source 20.

According to an embodiment, the total thickness of source 20, that is, the distance between surfaces 22 and 24, is smaller than 400 μm, preferably smaller than 300 μm, more preferably smaller than 250 μm. Preferably, source 20 comprises no portion filled with air or with partial vacuum. The total emission surface area of the source, seen along a direction orthogonal to upper surface 22, is greater than 2 cm², preferably greater than 5 cm², more preferably greater than 10 cm², in particular greater than 60 cm².

According to an embodiment, the surface density of the energy flux emitted by source 20 through upper surface 22 is greater than the surface density of the energy flux emitted by source 20 through lower surface 24. Preferably, the ratio of the surface density of the energy flux emitted by source 20 through lower surface 24 and the surface density of the energy flux emitted by source 20 through upper surface 22 is smaller than 0.4, preferably smaller than 0.3, more preferably smaller than 0.2, in particular smaller than 0.15. According to an embodiment, the surface density of the energy flux emitted by source 20 through upper surface 22 is greater than 600 μW/cm².

According to an embodiment, the surface density of the energy flux emitted by source 20 through upper surface 22 is substantially uniform all over upper surface 22. Calling Imax the maximum surface density of the energy flux emitted by source 20 through upper surface 22 and Imin the minimum surface density of the energy flux emitted by source 20 through upper surface 22, a ratio U, which is representative of the uniformity of the surface density of upper surface 22, is defined according to the following relation:

$$U = \frac{Imax - Imin}{Imax + Imin}$$

According to an embodiment, ratio U is smaller than 0.2, preferably smaller than 0.15, more preferably smaller than 0.12.

Source 20 is at least partly transparent to the radiation returned by object 12. According to an embodiment, the transmittance of the source to the useful wavelength is greater than 15%, preferably greater than 20%, more preferably greater than 25%.

The forward radiation emitted by source 20 may be a visible radiation and/or an infrared radiation. According to an embodiment, the useful wavelength is in the range from 500 nm to 550 nm, for example, equal to approximately 530 nm.

According to an embodiment, the total thickness of image acquisition system 10 is smaller than 600 μm. This enables to forming an image acquisition system 10 which is flexible.

Image sensor 14 comprises a support 26 and photodetectors 16, arranged between support 26 and angular filter 18. Photodetectors 16 may be covered with a transparent protection coating 28. Image sensor 14 further comprises conductive tracks and switching elements, particularly transistors, not shown, enabling to select photodetectors 16. Photodetectors 16 may be made of organic materials. Photodetectors 16 may correspond to organic photodiodes (OPD) or to organic photoresistors. The surface of image sensor 14 opposite angular filter 18 and containing photodetectors 15 is greater than 1 cm², preferably greater than 5 cm², more preferably greater than 10 cm², in particular greater than 20 cm².

Angular filter 18 is adapted to filtering incident radiation RI, which comprises the backward radiation emitted by source U20 and the portion of the returned radiation RO having crossed source 20, according to the incidence of the radiation relative to surface 24, particularly so that each photodetector 16 only receives the rays having their incidence with respect to an axis perpendicular to surface 24 smaller than a maximum angle of incidence smaller than 45°, preferably smaller than 20°, more preferably smaller than 10°, more preferably still smaller than 5°, in particular smaller than 4°. Angular filter 18 is capable of blocking the rays of the incident radiation RI having an incidence relative to an axis perpendicular to upper surface 24 greater than the maximum angle of incidence.

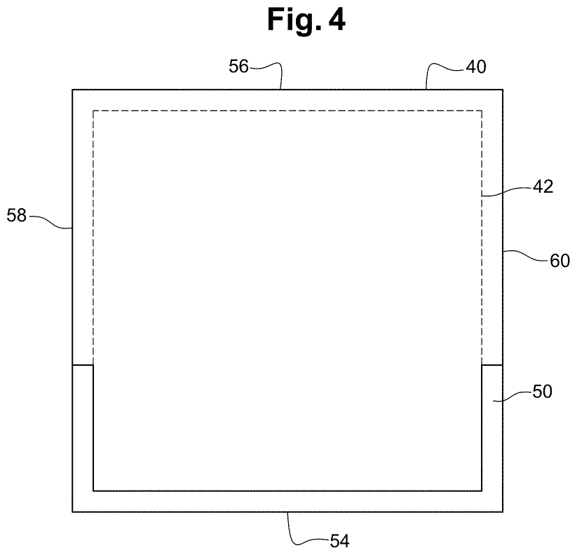

FIG. 3 is a partial simplified cross-section view of image acquisition system 10 illustrating a more detailed embodiment of light source 20 and FIG. 4 is a partial simplified top view of the light source 20 of FIG. 3.

In the present embodiment, light source 20 comprises a light-emitting diode, particularly an organic light-emitting diode (OLED). Light source 30 comprises a stack of layers comprising a first electrode layer 40, an active organic layer 42, and a second electrode layer 44, active layer 42 being sandwiched between electrode layers 40 and 44. Active layer 42 is the region from which most of the electromagnetic radiation supplied by source 20 is emitted. Light source 20 may further comprise a coating 46, delimiting upper surface 22 and covering electrode layer 40, on the side of electrode layer 40 opposite to active layer 42, and a coating 48, delimiting lower surface 24 and covering electrode layer 44, on the side of electrode layer 44 opposite to active layer 42. Interface layers 40 and 44 and coatings 46 and 48 are transparent to the useful radiation.

Light source 20 may further comprise a conductive strip 50 in contact with first electrode layer 40 over a portion of the periphery of first electrode layer 40 and a conductive strip 52 in contact with the second electrode layer 44 over a portion of the periphery of second electrode layer 44. Conductive strips 50, 52 are intended to be connected to a circuit for controlling light-emitting diode 20 and ease the injection and/or the collection of the current in electrode layers 40 and 44. Conductive strips 50 and 52 may be opaque to the useful radiation.

FIG. 4 schematically shows in full lines conductive strip 50 and electrode layer 40 and in dotted lines active layer 42 in the case where electrode layer 40 is the electron injection layer. In FIG. 4, electrode layer 40 has a rectangular shape comprising first and second opposite edges 54 and 56 and third and fourth opposite edges 58 and 60. According to an embodiment, conductive strip 50 extends all over the first edge 54 of electrode layer 40 and continues on a portion of the third and fourth edges 58 and 60 of electrode layer 40. As an example, conductive strip 50 may extend over ⅙th, ¼, ½, ¾ or the entire length of each of the third and fourth edges 58 and 60. Preferably, conductive strip 50 does not extend along edge 56.

Electrode layer 40 or 44 may correspond to an electron injection layer or to a hole injection layer. The work function of electrode layer 40 or 44 is capable of blocking, collecting, or injecting holes and/or electrons according to whether the electrode layer plays the role of a cathode or of an anode. More precisely, when electrode layer 40 or 44 plays the role of an anode, it corresponds to a hole injection and electron blocking layer. The work function of electrode layer 40 or 44 is then greater than or equal to 4.5 eV, preferably greater than or equal to 5 eV. When electrode layer 40 or 44 plays the role of a cathode, it corresponds to an electron injection and hole blocking layer. The work function of electrode layer 40 or 44 is then smaller than or equal to 4.5 eV, preferably smaller than or equal to 4.2 eV.

In the case where electrode layer 40 or 44 plays the role of an electron injection layer, the material forming electrode layer 40 or 44 is selected from the group comprising:
a metal oxide, particularly a titanium oxide or a zinc oxide;
a host/molecular dopant system, particularly the products commercialized by Novaled under trade names NET-5/NDN-1 or NET-8/MDN-26;
a conductive or doped semiconductor polymer, for example, the PEDOT:Tosylate polymer, which is a mixture of poly(3,4)-ethylenedioxythiophene and of tosylate;
a carbonate, for example CsCO₃;
a polyelectrolyte, for example, poly[9,9-bis(3′-(N,N-dimethylamino)propyl)-2,7-fluorene-alt-2,7-(9,9-dioctyfluorene)] (PFN), poly[3-(6-trimethylammoniumhexyl] thiophene (P3TMAHT), or poly[9,9-bis(2-ethylhexyl)fluorene]-b-poly[3-(6-trimethylammoniumhexyl] thiophene (PF2/6-b-P3TMAHT);
a polyethyleneimine (PEI) polymer or a polyethyleneimine ethoxylated (PEIE), propoxylated, and/or butoxylated polymer; and
a mixture of two or more of these materials.

In the case where electrode layer 40 or 44 plays the role of a hole injection layer, the material forming electrode layer 40 or 44 may be selected from the group comprising:
a conductive or doped semiconductor polymer, particularly the materials commercialized under trade names Plexcore OC RG-1100, Plexcore OC RG-1200 by Sigma-Aldrich, the PEDOT:PSS polymer, which is a mixture of poly(3,4)-ethylenedioxythiophene and of sodium polystyrene sulfonate, or a polyaniline;
a molecular host/dopant system, particularly the products commercialized by Novaled under trade names NHT-5/NDP-2 or NHT-18/NDP-9;
a polyelectrolyte, for example, Nafion;
a metal oxide, for example, a molybdenum oxide, a vanadium oxide, ITO, or a nickel oxide; and
a mixture of two or more of these materials.

Conductive strips 50 and 52 may be metallic.

Active layer 42 comprises at least one organic material and may comprise a stack or a mixture of a plurality of organic materials. Active layer 42 may comprise a mixture of an electron donor polymer and of an electron acceptor molecule. The functional area of active layer 42 is delimited by the overlapping of electrode layer 40 and of electrode layer 44. The currents crossing the functional area of active region 42 may vary from a few picoamperes to a few microamperes.

Active layer 42 may comprise small molecules, oligomers, or polymers. These may be organic or inorganic materials. Active layer 42 may comprise an ambipolar semiconductor material, or a mixture of an N-type semiconductor material and of a P-type semiconductor material, for example in the form of stacked layers or of an intimate mixture at a nanometer scale to form a bulk heterojunction.

Example of P-type semiconductor polymers capable of forming active layer 42 are poly(3-hexylthiophene) (P3HT), poly[N-9′-heptadecanyl-2,7-carbazole-alt-5,5-(4,7-di-2-thienyl-2′,1′,3′-benzothiadiazole] (PCDTBT), Poly[(4,8-bis-(2-ethylhexyloxy)-benzo[1,2-b;4,5-b′]dithiophene)-2,6-diyl-alt-(4-(2-ethylhexanoyl)-thie-no[3,4-b]thiophene))-2,6-diyl];4,5-b′]dithi-ophene)-2,6-diyl-alt-(5,5′-bis(2-thienyl)-4,4,-dinonyl-2,2′-bithiazole)-5′,5″-diyl] (PBDTTT-C), le poly[2-methoxy-5-(2-ethyl-hexyloxy)-1,4-phenylene-vinylene] (MEH-PPV) or Poly[2,6-(4,4-bis-(2-ethylhexyl)-4H-cyclopenta [2,1-b;3,4-b′]dithiophene)-alt-4,7(2,1,3-benzothiadiazole)] (PCPDTBT).

Examples of N-type semiconductor materials capable of forming active layer 42 are fullerenes, particularly C60, [6,6]-phenyl-C61-butyric acid methyl ester ([60]PCBM), [6,6]-phenyl-C71-butyric acid methyl ester ([70]PCBM), perylene diimide, zinc oxide (ZnO), or nanocrystals enabling to form quantum dots.

Coatings 46 and 48 may be made of glass or of polymer, particularly, polymers formed based on tetrafluoroethylene (TFE).

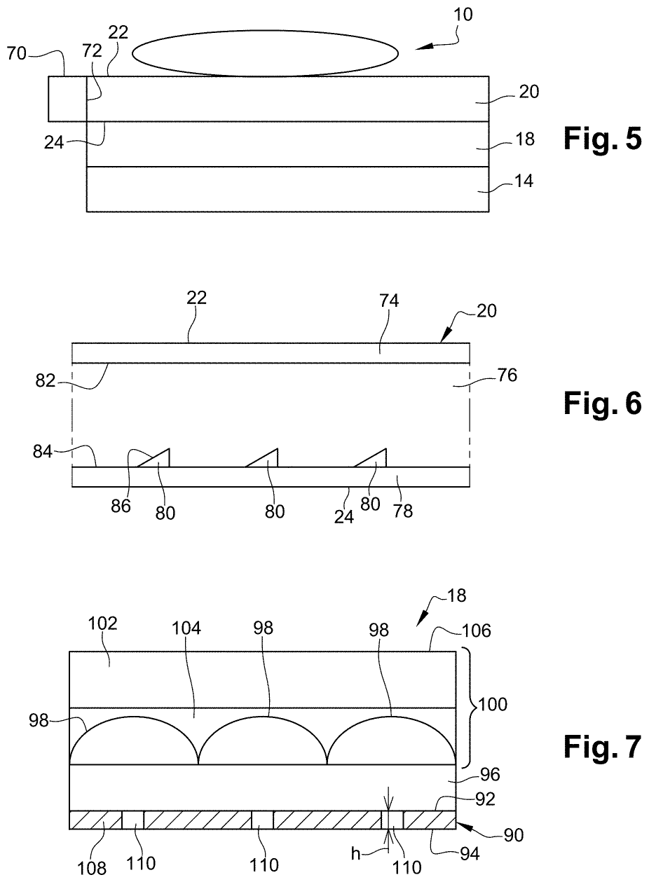

FIG. 5 is a partial simplified cross-section view of image acquisition system 10 illustrating another more detailed embodiment of source 20 where the light source corresponds to a light waveguide, also called waveguide or light guide, covering angular filter 18 and having a radiation supplied by an emitting source 70, for example comprising light-emitting diodes, injected into it. The radiation may be injected into waveguide 20 from the periphery of the waveguide, along a single side or a plurality of sides of waveguide 20. According to an embodiment, all the light-emitting diodes may emit a radiation at the same central wavelength or light-emitting diodes may emit radiations at different central wavelengths. In the embodiment shown in FIG. 5, the radiation is injected into waveguide 20 from a lateral edge 72 of waveguide 20. According to another embodiment, the radiation is injected into waveguide 20 at the periphery of the waveguide through upper surface 22 or lower surface 24, preferably through lower surface 24.

FIG. 6 is a partial simplified cross-section view of an embodiment of the waveguide 20 of FIG. 5. Waveguide 20 comprises, from top to bottom in FIG. 6:
an upper sheath 74 delimiting upper surface 22;
a core 76;
a lower sheath 78 delimiting lower surface 24, core 76 being sandwiched between lower sheath 78 and upper sheath 74; and
micrometer-range raised patterns 80 resting on lower sheath 78 on the side of core 76.

Core 76 may have a single-layer structure or a multi-layer structure. In the case where the core has a multilayer structure, all the layers forming core 76 have substantially the same refraction index. In particular, core 76 may comprises at least one stack of first and second sub-layers, not shown in FIG. 6, of different materials having substantially equal refraction indexes, the first sub-layer forming the most part of core 76 and the second sub-layer covering lower sheath 78 and patterns 80 and being only present to allow the forming of patterns 80. Upper sheath 74, lower sheath 78, and patterns 80 may be made of the same material or of different materials. Patterns 80 may be made of the same material as lower sheath 78. In particular, patterns 80 and lower sheath 78 may form a monoblock structure. In particular, patterns 80 and lower sheath 78 may correspond to an air film. The refraction index of the material forming core 76 is greater than the refraction index of the material forming upper sheath 74, lower sheath 78, and patterns 80 or, in the case where upper sheath 74, lower sheath 78, and/or patterns 80 are made of different materials, refractions indexes of the materials forming upper sheath 74, lower sheath 78, and patterns 80.

Upper sheath 74 comprises a surface 82 in contact with core 76. Preferably, surface 82 is planar and parallel to upper surface 22. Lower sheath 78 comprises a surface 84 having patterns 80 resting thereon and which is, outside of patterns 80, in contact with core 76. Preferably, surface 44 is planar and parallel to lower surface 24. Upper sheath 74 particularly enables to avoid the obtaining of an extraction of light when object 12 comes into contact with waveguide 20. Upper sheath 74 may further be used as a protection coating of core 76.

Patterns 80 increase the extraction of the radiation injected into waveguide 20 through upper surface 22. Patterns 80 may have the same shape or different shapes. As an example, each pattern 80 may comprise a planar surface 86 inclined with respect to upper surface 22. As an example, each pattern 80 may have a prismatic shape. The density of patterns 80 on surface 84 may be non-constant. In particular, the density of patterns 80 may increase when the distance to the area of injection of radiation into waveguide 20 or the areas of injection of radiation into waveguide 20 increases. As an example, when the radiation is injected into waveguide 20 on an edge of the waveguide, the density of patterns 80 on surface 84 increases together with the distance from this edge. The variation of the pattern density enables to keep a uniformity of the spectral density of the forward radiation flux emitted by upper surface 22 while the spectral density of the radiation flux propagating into waveguide 20 decreases as the distance to the area of injection of radiation into waveguide 20 or to the areas of injection of radiation into waveguide 20 increases.

According to an embodiment, the thickness of core 76 may be in the range from 100 μm to 600 μm. According to an embodiment, the thickness of upper sheath 74 may be in the range from 1 μm to 150 μm, preferably from 30 μm to 80 μm. According to an embodiment, the thickness of lower sheath 78 may be in the range from 1 μm to 150 μm. The maximum height of each pattern 80, measured with respect to surface 84, may be in the range from 0.5 μm to 6 μm, preferably from 2 μm to 5 μm. Patterns 80 may each have a width smaller than 20 μm, preferably smaller than 12 μm, more preferably between 2 μm and 6 μm.

According to an embodiment, core 76 may be made of polycarbonate (PC), polymethyl methacrylate (PMMA), polyethylene terephthalate (PET), or cyclic olefin polymer (COP). According to an embodiment, upper sheath 74, lower sheath 78, and/or patterns 80 may be made up of an optically clear adhesive (OCA), particularly a liquid optically clear adhesive (LOCA), or a material with a low refraction index, or an epoxy/acrylate glue, or a film of a gas or of a gaseous mixture. According to an embodiment, the refraction index of core 76 is in the range from 1.45 to 1.7, and the refraction index of upper sheath 74, of lower sheath 76, and of patterns 80 is in the range from 1 to 1.55. The difference between the refraction index of core 76 and the refraction index of upper sheath 74, of lower sheath 76, and of patterns 80 is greater than 0.07, preferably greater than 0.1. Waveguide 20 may be formed according to a sheet-by-sheet procedure, or a roll-by-roll procedure.

FIG. 7 is a partial simplified cross-section view of an embodiment of angular filter 18. Angular filter 18 comprises, from bottom to top in FIG. 7:
a layer with openings 90 having upper and lower surfaces 92 and 94, for example, planar and parallel;
an intermediate layer 96 covering the layer with openings 90;
an array of micrometer-range focusing optical elements 98; and
a coating 100.

The array of micrometer-range optical elements 98 for example corresponds to an array of microlenses 98 covering intermediate layer 96. Intermediate layer 96 may play the role of a support of the array of microlenses 98, and intermediate layer 96 and microlens array 98 may correspond to a monolithic structure. The microlenses may be plano-convex microlenses or index gradient microlenses. As a variant, the array of micrometer-range optical elements 98 may correspond to an array of micrometer-range diffraction gratings.

Coating 100 for example comprises a stack of a plurality of layers, for example, two layers 102 and 104, and comprises an upper surface 106. Preferably, upper surface 106 is planar and in contact with the lower surface 24 of light source 20. In particular, lower layer 104 may play the role of a planarizing layer on microlenses 98 and have a refraction index smaller than the refraction index of microlenses 98 and upper layer 102 may be a plastic film or an adhesive film for the association with waveguide 20.

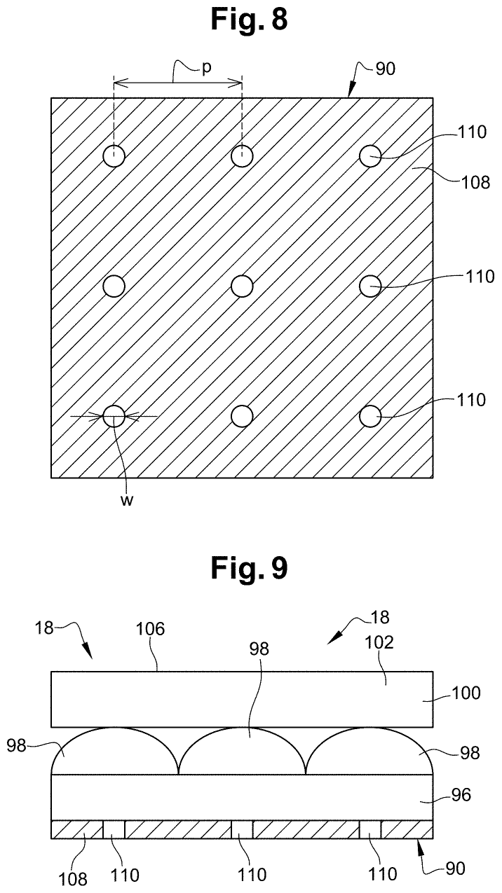

FIG. 8 is a bottom view of the layer with openings 90 shown in FIG. 7. In the present embodiment, the layer with openings 90 comprises an opaque layer 108 crossed by holes 110, also called openings. Preferably, holes 110 are through holes since they extend across the entire thickness of layer 108. According to another embodiment, holes 110 may only extend across a portion of the thickness of opaque layer 108, a residual portion of opaque layer 108 remaining at the bottom of holes 110. However, in this case, the thickness of the residual portion of opaque layer 108 at the bottom of hole 110 is sufficiently low for the assembly comprising hole 110, possibly filled, and the residual portion of opaque layer 108 at the bottom of hole 110 to be able to be considered as transparent to the useful radiation.

According to an embodiment, the distribution of holes 110 follows the distribution of microlenses 98. As an example, FIG. 8 corresponds to the case where the microlenses are distributed in a square mesh. However, other layouts of microlenses 98 are possible, for example, in a hexagonal mesh. Call “h” the thickness of layer 90, which also corresponds to the height of holes 110 in the case of through holes. Layer 108 is opaque to all or to part of the spectrum of the incident radiation. Layer 108 may be opaque to the useful radiation, for example, absorbing and/or reflective with respect to the useful radiation. According to an embodiment, layer 108 is absorbing in the visible range or a portion of the visible range and/or near infrared and/or infrared.

In FIG. 8, holes 110 are shown with a circular cross-section. Generally, holes 110 may have any cross-section in top view, for example, circular, oval, or polygonal, particularly, triangular, square, or rectangular according to the manufacturing method used. Further, in FIG. 7, holes 110 are shown with a constant cross-section across the entire thickness of opaque layer 108. However, the cross-section of each hole 110 may vary across the thickness of opaque layer 108. As an example, the cross-section of each hole 110 may decrease as the distance to microlenses 98 increases. According to an embodiment, holes 110 have a substantially frustoconical shape. According to an embodiment, the diameter of holes 110 on the side of surface 92 is in the range from 2 μm to 10 μm and the diameter of holes 110 on the side of surface 94 is in the range from 1 μm to 5 μm. According to an embodiment, the diameter of holes 110 on the side of surface 92 is greater than 10 μm and the diameter of holes 110 on the side of surface 94 is greater than 5 μm. In the case where holes 110 are formed by a method comprising photolithography steps, the shape of the holes may be adjusted by the method parameters such as the exposure dose, the development time, the divergence of the photolithography exposure source as well as by the shape of the microlenses.

According to an embodiment, holes 110 are arranged in rows and in columns. Holes 110 may have substantially the same dimensions. Call “w” the width of a hole 110 measured along the row or column direction. Width w corresponds to the diameter of hole 18 in the case of a hole having a circular cross-section. According to an embodiment, holes 110 are regularly arranged along the rows and along the columns. Call “p” the repetition pitch of holes 110, that is, the distance in top view between the centers of two successive holes 110 of a row or of a column. As described in further detail hereafter, the layout of the holes copies the layout of microlenses 98.

Ratio h/w may vary from 1 to 10, or even be greater than 10. Pitch p may vary from 1 μm to 500 μm, preferably from 1 μm to 100 μm, more preferably from 10 μm to 50 μm, for example, equal to approximately 15 μm. Height h may vary from 0.1 μm to 1 mm, preferably from 1μ to 130 μm, more preferably from 10 μm to 130 μm or from 1 μm to 20 μm. Width w may vary from 0.1 μm to 100 μm, preferably from 1 μm to 10 μm, for example, equal to approximately 2 μm. Holes 110 may all have the same width w. As a variant, holes 110 may have different widths w.

Microlenses 98 are converging lenses, each having a focal distance f in the range from 1 μm to 100 μm, preferably from 5 μm to 50 μm. According to an embodiment, all the microlenses 98 are substantially identical. According to an embodiment, the maximum thickness of microlenses 98 is in the range from 1 μm to 20 μm.

The combination of microlenses 98 and of holes 110 enables to optimize two important parameters. More particularly, this enables to increase the transmittance at normal incidence while decreasing the viewing angle. Without microlenses 98, optimizing these two parameters requires openings having a very low width-to-height ratio and a significant filling factor, which is very difficult to achieve in practice. Adding microlenses 98 on holes 110 enables to release the constraint relative to the form factor of the openings and the filling factor.

The layer with openings 90 may have a monolayer structure or a multilayer structure. In the case where the layer with openings 90 comprises a multilayer structure, holes 110 may extend in all the layers of the multilayer structure. In particular, the layer with openings 90 may comprise a stack of three layers, including a transparent layer interposed between two opaque layers. Generally, the layer with openings 90 may comprise a stack of more than two opaque layers, each opaque layer being crossed by holes, the opaque layers of each pair of adjacent opaque layers being spaced apart or not by one or a plurality of transparent layers.

FIG. 9 is a cross-section view of a variant of angular filter 18 where coating 100 only comprises layer 102, which corresponds to a film applied against the array of microlenses 98. In this case, the contact area between layer 102 and microlenses 98 may be decreased, for example limited to the tops of microlenses 98. Layer 102 may be used to protect microlenses 98, and/or to form a substantially planar surface to simplify the assembly with an upper layer. Layer 102 may also be an adhesive layer to assemble angular filter 18 to an upper layer.

The refraction index of the material forming the array of optical elements 98 is noted n1. The refraction index of the material forming intermediate layer 96 is noted n2. The refraction index of the material forming opaque layer 108 is noted n3. The refraction index of the filling material of holes 110 is noted n4. The refraction index n3 of layer 108 is smaller than the refraction index n1 of the array of microlenses 98. According to an embodiment, the refraction index of layer 108 is in the range from 1.2 to 1.5 and the refraction index of microlenses 98 is in the range from 1.4 to 1.7.

According to an embodiment, layer 108 is made of positive resist, that is, resist for which the portion of the resin layer exposed to a radiation becomes soluble to a developer and where the portion of the resist layer which is not exposed to the radiation remains non-soluble in the developer. Opaque layer 108 may be made of colored resin, for example, a colored or black DNQ-Novolack resin or a DUV (Deep Ultraviolet) resist. DNQ-Novolack resins are based on a mixture of diazonaphtoquinone (DNQ) and of a novolack resin (phenolformaldehyde resin). DUV resists may comprise polymers based on polyhydroxystyrenes.

According to another embodiment, the filling material of holes 110 is made of negative resist, that is, resist for which the portion of the resin layer exposed to a radiation becomes non-soluble to a developer and where the portion of the resist layer which is not exposed to the radiation remains soluble in the developer. Examples of negative resists are epoxy polymer resins, for example, the resin commercialized under name SU-8, acrylate resins, and off-stoichiometry thiol-ene (OSTE) polymers. This resin should then be transparent to the incident radiation.

According to another embodiment, layer 108 is made of a laser-machinable material, that is, a material capable of degrading under the action of a laser radiation. Examples of laser-machinable materials are graphite, a low-thickness metal film (typically from 50 nm to 100 nm), plastic materials such as poly(methyl methacrylate) (PMMA), acrylonitrile butadiene styrene (ABS), or dyed plastic films such as polyethylene terephthalate (PET), poly(ethylene naphthalate) (PEN), cyclo olefin polymers (COP), and polyimides (PI).

Further, as an example, layer 108 may be made of black resin absorbing in the visible range and/or in near infrared. According to another example, layer 108 may further be made of colored resin absorbing visible light of a given color, for example, blue, green, or cyan, or infrared light. This may occur when angular filter 18 is used with an image sensor 14 which is only sensitive to light of a given color. This may further be the case when angular filter 18 is used with an image sensor 14 which is sensitive to visible light and a filter of the given color is interposed between image sensor 14 and the object 12 to be imaged.

When the layer with openings 90 is formed of a stack of at least two opaque layers, each opaque layer may be made of one of the previously-mentioned materials, and the opaque layers may be made of different materials.

According to an embodiment, the layer comprising openings 90 comprises a base layer made of a first material opaque or at least partially transparent to the useful radiation and covered with a coating opaque to the useful radiation, for example, absorbing and/or reflective with respect to the useful radiation. The first material may be a resin. The second material may be a metal, for example, aluminum (Al) or chromium (Cr), a metal alloy, or an organic material. The material may cover the walls of holes 110 or not according to the characteristics of the layer with openings 90. The coating may cover the base layer, on the side of the base layer which is opposite to microlenses 98 or cover the base layer on the side facing microlenses 98. The coating advantageously enables to increase the obstruction, either by reflection or by absorption, of angular filter 18 with respect to the oblique light rays.

Holes 110 may be filled with air or filled with a solid, liquid, or gaseous material, particularly air, at least partially transparent to the useful radiation, for example polydimethylsiloxane (PDMS). As a variant, holes 110 may be filled with a partially absorbing material to filter the wavelengths of the rays of the useful radiation. Angular filter 18 may then further play the role of a wavelength filter. This enables to decrease the thickness of image acquisition system 10 with respect to the case where a colored filter different from angular filter 18 would be present. The partially absorbing filling material may be a colored resin or a colored plastic material such as PDMS.

The filling material of holes 110 may be selected to have a refraction index matching with the intermediate layer 96 in contact with layer 90 comprising openings and/or to rigidify the structure and improve the mechanical resistance of the layer with openings 90, and/or to increase the transmission at a normal incidence. Further, the filling material may also be a liquid or solid adhesive material enabling to assemble angular filter 18 on another device, for example, image sensor 14. The filling material may also be an epoxy or acrylate glue used to encapsulate the device having the optical system resting on a surface thereof, for example, an image sensor, considering that layer 96 is an encapsulation film. In this case, the glue fills holes 110 and is in contact with the surface of image sensor 114. The glue also enables to laminate angular filter 18 on image sensor 14.

Intermediate layer 96, which may be omitted, is at least partially transparent to the useful radiation. Intermediate layer 96 may be made of a transparent polymer, particularly of PET, of PMMA, of COP, of PEN, of polyimide, of a layer of dielectric or inorganic polymers (SiN, SiO₂), or of a thin glass layer. As previously indicated, layer 96 and the array of microlenses 98 may correspond to a monolithic structure. Further, layer 96 may correspond to a layer of protection of image sensor 14, having angular filter 18 attached thereon. If the image sensor is made of organic materials, layer 96 may correspond to a water- and oxygen-tight barrier film protecting the organic materials. As an example, this protection layer may correspond to a SiN deposit in the order of 1 μm on the surface of a PET, PEN, COP, and/or PI film in contact with layer 90 comprising openings. The thickness of intermediate layer 96 or the thickness of the air film when intermediate layer 96 is replaced with an air film is in the range from 1 μm to 500 μm, preferably from 5 μm to 50 μm.

Coating 100 is at least partially transparent to the useful radiation. Coating 100 may have a maximum thickness in the range from 0.1 μm to 10 mm. Upper surface 106 may be substantially planar or have a curved shape.

According to an embodiment, layer 104 is a layer which follows the shape of microlenses 98. Layer 104 may be obtained from an optically clear adhesive (OCA), particularly a liquid optically clear adhesive (LOCA), or a material having a low refraction index, or an epoxy/acrylate glue, or a film of a gas or of a gaseous mixture, for example, air. Preferably, when layer 104 follows the shape of microlenses 98, layer 104 is made of a material having a low refraction index, lower than that of the material of microlenses 98. Layer 104 may be made of a filling material which is a non-adhesive transparent material. According to another embodiment, layer 104 corresponds to a film which is applied against the array of microlenses 98, for example, an OCA film. In this case, the contact area between layer 104 and microlenses 98 may be decreased, for example, limited to the tops of the microlenses. Layer 104 may then be made of a material having a higher refraction index than in the case where layer 104 follows the shape of microlenses 98 According to another embodiment, layer 104 corresponds to an OCA film which is applied against the array of microlenses 98, the adhesive having properties which enable film 104 to completely or substantially completely follow the surface of the microlenses. According to an embodiment, the refraction index of layer 104 is smaller than the refraction index of microlenses 98. According to an embodiment, layer 102 may be made of one of the materials previously indicated for layer 104. Layer 102 may be omitted. The thickness of layer 102 is in the range from 1 μm to 100 μm.

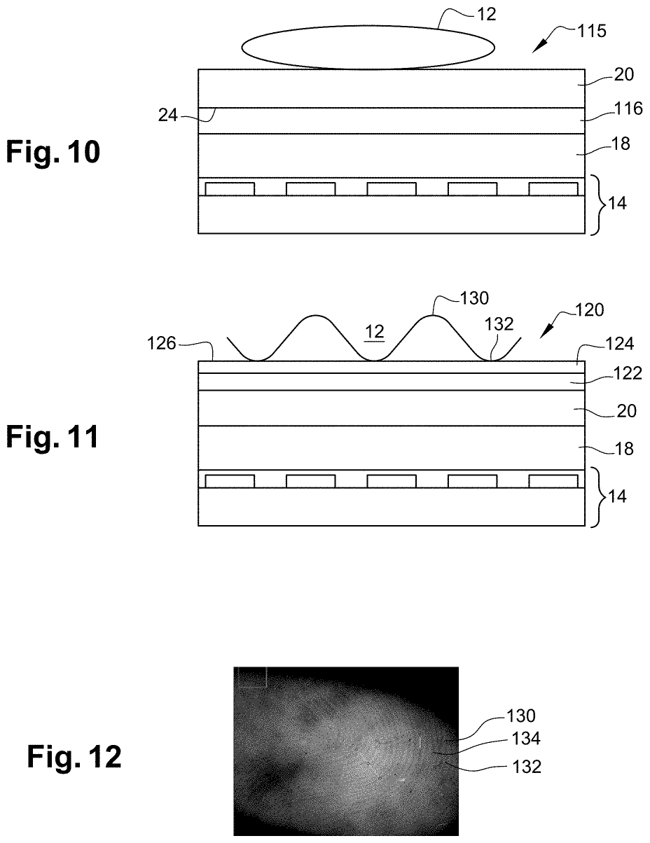

FIG. 10 is a partial simplified cross-section view of another embodiment of an image acquisition system 115 of object 12. Image acquisition system 115 comprises all the elements of the image acquisition system 10 shown in FIG. 2 and further comprises an optical filter 116 interposed between angular filter 18 and source 20. Optical filter 116 enables to filter the wavelength of the radiation coming out of the lower surface 24 of source 20 to only give way to the radiation having its spectrum belonging to a determined wavelength. Optical filter 116 may correspond to a colored layer, particularly a colored resin layer. The thickness of optical filter 116 may be in the range from 20 μm to 1.5 mm, preferably from 20 μm to 400 μm, more preferably from 20 μm to 100 μm.

FIG. 11 is a partial simplified cross-section view of another embodiment of an image acquisition system 120 of object 12. Image acquisition system 120 comprises all the elements of the image acquisition system 10 shown in FIG. 2 and further comprises a polarizer 122. In the embodiment shown in FIG. 11, polarizer 122 is interposed between light source 20 and the object 12 to be imaged. As a variant, polarizer 122 may be interposed between light source 20 and angular filter 18, particularly in the case where the forward radiation supplied by source 20 to finger 17 is polarized. Image acquisition system 120 may further comprise a transparent coating 124 covering polarizer 122 and delimiting a surface 126 capable of coming into contact with the object 12 to be imaged. This coating 124 may form a mechanical protection. Polarizer 122 is preferably a rectilinear polarizer. Polarizer 122 is adapted to filtering the radiation which crosses it to only give way to the radiation polarized along a preferred direction. Polarizer 122 may correspond to a meta-material and have a thickness in the order of 100 nm, or correspond to an organic film or an inorganic film, for example, of polyvynil alcohol (PVA) comprising dichroic dyes and iodine dyes, having a thickness in the range from 35 μm to 150 μm.

According to an embodiment, not shown, the image acquisition system comprises two polarizers, the first polarizer being interposed between light source 20 and the object 12 to be imaged and the second polarizer being interposed between light source 20 and angular filter 18. The polarization directions of the first and second polarizers are then substantially parallel.

The use of the image acquisition system 120 shown in FIG. 11 may in particular be advantageous for the acquisition of fingerprints of a finger 12 comprising valleys 130 and ridges 132.

FIG. 12 shows an image of the fingerprint of a finger acquired by the acquisition system 10 shown in FIG. 2. The image shows the valleys 130, light-colored, and the ridges 132, darker, of the fingerprints and also pores 134, lighter, on ridges 132.

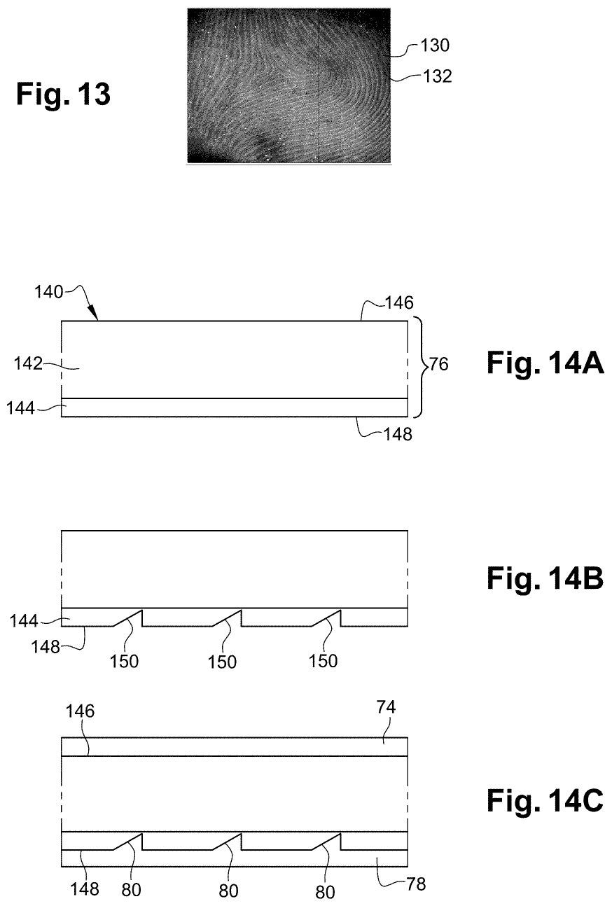

FIG. 13 shows an image of the fingerprint of a finger acquired by the acquisition system 120 shown in FIG. 11. One can distinguish on the image valleys 130 and ridges 132 with a contrast increased with respect to the image of FIG. 12. An explanation would be that the light that reflects at the finger surface keeps its polarization acquired by crossing polarizer 122 while the light that penetrates into the finger loses its polarization acquired by crossing polarizer 122 and will be significantly attenuated during the second passage through this polarizer 122. The depth information no longer interferes with the direct signal of the ridges and of the valleys. The image of FIG. 13 may advantageously be better adapted to a fingerprint recognition processing.

According to the material used, the method of forming the layers of image sensor 14, of angular filter 18, and of source 20 may correspond to a so-called additive process, for example, by direct printing of a fluid or viscous composition comprising the material at the desired locations, for example, by inkjet printing, photogravure, silk-screening, flexography, spray coating, or drop casting. According to the material used, the method of forming the layers of image sensor 14, of angular filter 18, and of source 20 may correspond to a so-called subtractive method, where the material is deposited all over the structure and where the non-used portions are then removed, for example, by photolithography or laser ablation. According to the considered material, the deposition over the entire structure may be performed, for example, by liquid deposition, by cathode sputtering, or by evaporation. Methods such as spin coating, spray coating, heliography, slot-die coating, blade coating, flexography, or silk-screening, may in particular be used. According to the implemented deposition method, a step of drying the deposited material may be provided.

FIGS. 14A to 14C are partial simplified cross-section views of structures obtained at successive steps of another embodiment of a method of manufacturing the waveguide 20 shown in FIG. 6.

FIG. 14A shows the structure obtained after the forming of core 76 comprising a stack 140 comprising two layers 142 and 144. Layer 142 is for example made of polymer. The thickness of layer 142 is equal to at least 60% of the total thickness of core 76, preferably to at least 70% of the total thickness of core 76. Layer 144 is for example made of resin. The refraction index of layer 144 is substantially equal to the refraction index of layer 142. Stack 140 provides two opposite surfaces 146 and 148, preferably planar and parallel.

FIG. 14B shows the structure obtained after a step of forming in surface 148 impressions 150 having a shape complementary to that of the desired patterns. Impressions 150 may be formed by an etch step, for example, by using a resin sensitive to UV radiation or by laser etching. As a variant, impressions 150 may be formed by thermoforming.

FIG. 14C shows the structure obtained after the forming of upper sheath 74, of lower sheath 78, and of patterns 80. This may be done by the deposition of layers on the two opposite surfaces 146 and 148 of stack 140, the first layer deposited on surface 146 forming upper sheath 74 and the second layer deposited on surface 148 forming lower sheath 76 and filling impressions 144 to form patterns 80.

Various embodiments and variants have been described. Those skilled in the art will understand that certain features of these embodiments can be combined and other variants will readily occur to those skilled in the art. In particular, the embodiments previously described in relation with FIGS. 10 and 11 may be combined, and the image acquisition system may comprise optical filter 116 and polarizer 122. Finally, the practical implementation of the described embodiments and variants is within the abilities of those skilled in the art based on the functional indications given hereabove.

1. An image acquisition system for acquiring images of an object comprising: a stack of layers having a total thickness smaller than 600 μm, said stack comprising:
an image sensor comprising an array of photodetectors;
a source of a radiation (RF) having a thickness smaller than 400 μm and comprising first and second opposite surfaces, said source comprising a light guide covering the entire image sensor, the photodetectors being adapted for detecting at least a portion of said radiation reflected by the object, the second surface facing a side of the image sensor, the second surface covering the entire photodetector array, a surface density of an energy flux emitted by the source through the first surface being greater than 100 μW/cm², a ratio of a surface density of an energy flux emitted by the source through the second surface to the surface density of the energy flux emitted by the source through the first surface being smaller than 0.4, a transmittance of the source to said portion of the radiation being greater than 15%; and
an angular filter covering the image sensor and interposed between the source and the image sensor, and adapted to blocking rays of said radiation having an incidence relative to a direction orthogonal to the first surface greater than a threshold and of giving way to rays of said radiation having an incidence relative to a direction orthogonal to the first surface smaller than the threshold,
wherein the light guide comprises a core interposed between first and second sheaths, the second sheath being arranged between the core and the angular filter, a refraction index of the core for the radiation being greater than a refraction index of the first and second sheaths for the radiation, the light guide comprising, between the second sheath and core, micrometer-range patterns projecting in relief from the second sheath into the core.

2-3. (canceled)

4. The image acquisition system according to claim 1, wherein the light guide comprises an area through which the radiation is injected into the light guide, and wherein the surface density of the patterns on the second sheath increases as the distance to said area increases.

5. The image acquisition system according to claim 1, wherein the radiation (RF) is in a visible range and/or in an infrared range.

6. The image acquisition system according to claim 1, wherein the angular filter comprises:
an array of micrometer-range focusing elements; and
a layer opaque to the radiation and crossed by holes, the holes being filled with air or with a material at least partially transparent to said radiation.

7. The image acquisition system according to claim 6, wherein, for each hole, the ratio of a height of the hole, measured perpendicularly to the first surface, to a width of the hole, measured parallel to the first surface, varies from 1 to 10.

8. The image acquisition system according to claim 6, wherein the holes are arranged in rows, a pitch between adjacent holes of a same row or of a same column varying from 1 μm to 30 μm.

9. The image acquisition system according to claim 6, wherein a height of each hole, measured along a direction orthogonal to the first surface, varies from 1 μm to 1 mm.

10. The image acquisition system according to claim 6, wherein a width of each hole, measured parallel to the first surface, varies from 2 μm to 30 μm.

11. The image acquisition system according to claim 6, wherein the micrometer-range focusing elements are micrometer-range lenses.

12. The image acquisition system of according to claim 1, wherein the photodetectors comprise organic photodiodes.

13. The image acquisition system according to claim 1, further comprising a first polarizer covering the first surface.

14. The image acquisition system according to claim 13, further comprising a second polarizer.

15. The image acquisition system according to claim 14, wherein the first polarizer is interposed between the light source and the object to be imaged and the second polarizer is interposed between the light source and the angular filter.

16. A use of the image acquisition system according to claim 1, for the detection of at least one fingerprint of a user, comprising contact imaging.

17. The image acquisition system according to claim 7, wherein the holes are arranged in rows, a pitch between adjacent holes of a same row or of a same column varying from 1 μm to 30 μm.

18. The image acquisition system according to claim 7, wherein a height of each hole, measured along a direction orthogonal to the first surface, varies from 1 μm to 1 mm.

19. The image acquisition system according to claim 7, wherein a width of each hole, measured parallel to the first surface, varies from 2 μm to 30 μm.

20. The image acquisition system according to claim 7, wherein the micrometer-range focusing elements are micrometer-range lenses.
